(19) United States
(12) Patent Application Publication
(10) Pub. No.: US 2002/0023332 A1
(43) Pub. Date: Feb. 28, 2002

(54) Method of repairing farrowing crate

(76) Inventor: Jozef Hudak, Ansonville, NC (US)

Correspondence Address: Dougherty & Clements LLP, Two Fairview Center, 6230 Fairview Road, Suite 400, Charlotte, NC, 28210, US

(21) Appl. No.: 09/750,843

(22) Filed: Dec. 28, 2000

Related U.S. Application Data
(63) Continuation-in-part of application No. 09/649,150, filed on Aug. 28, 2000.

(51) Int. Cl. B23P 19/04

(52) U.S. Cl. 29/402.08

(57) ABSTRACT

An improved method and apparatus for repairing a farrowing crate, particularly a portion of the grating floor of the crate which is frequently damaged and in need of replacement. The method provides for cutting and removing a rectangular portion of the grate including the damaged portion, then replacing it with a removable and replaceable section, and fastening the removable section into place. The apparatus includes a receiving and positioning bar for connecting one end of the replacement section to the basic grate, a longitudinal seal-plate member attached to each longitudinal side of the replacement section, and an attachment device for fixing and holding the replacement section firmly in the operating position. Alternatively, the replacement section may engage a pair of bottom side supports.

### CROSS-REFERENCE TO RELATED APPLICATION

This application is a continuation-in-part of U.S. patent application Ser. No. 09/649,150, filed on Aug. 28, 2000.

### FIELD OF THE INVENTION

The present invention relates to grated flooring for use in farrowing pens for animals, particularly for pigs, and more particularly the invention relates to a method and apparatus for replacing a portion of a grated flooring.

In the intensive raising of pigs and hogs, the expectant sow is placed in a farrowing pen or crate. Sows usually spend from 18 to 20 days in the farrowing crates while they farrow and nurse their piglets. Each farrowing pen includes a farrowing crate, which is a metal frame structure for confining the sow. The crate has a grated floor, underneath which is a manure containment pit. The crate is narrow, so that the sow generally cannot reverse itself One end of the crate has a feed facility, and the sow is placed in the crate so its snout is near the “feed end”.

Because of the corrosiveness of the manure and urine which falls on the grate, the central portion of the grate, at the end opposite from the feed end of the crate, is subject to damage, necessitating frequent replacement of the crate floor so that piglets do not fall through when a hole is formed. In addition, on occasion, manure will pack so tightly in the floor that the grate needs to be replaced rather than cleaned in order to avoid disease to the sow and the piglets.

Floor grates must be repaired after a few years of use. Heretofore, broken, worn and clogged grates of farrowing crates have been repaired by complete replacement of all of the parts, not only those parts that are worn, corroded and broken, but also those parts that are unworn and undamaged. A specially trained crew, consisting of two or more persons, is required to handle the replacement, which takes a period of several hours, and is extremely expensive, both in terms of time and money.

An alternative way of repairing broken grates is to cover the broken portion with a new grate. This reduces the size of the passageway for waste and causes a buildup of manure, resulting in piglets being in a dirty environment, which is unsatisfactory. The covering grate may also be unstable and shift with activity in the crate. Further, it may have rough wire ends which are exposed, and which may cut the hide of a piglet.

By utilizing the present invention, any farm employee can handle replacement of a damaged portion of a grate in a farrowing crate with a minimum of time and expense.

Most crate floor grates are made of metal, usually steel wire, but they can be made of other materials, including galvanized (zinc-coated) wire, stainless steel, or plastics, such as high strength plastics or fiber-glass reinforced plastics. Preferably the grate is made of woven steel wire.

With the present invention, since only a portion of the grate is normally damaged by use, it is not necessary to replace the entire crate when damaged.

### OBJECTS OF THE INVENTION

It is the principal object of the present invention to provide a method for repairing a damaged farrowing crate floor grate.

It is also an object of this invention to provide apparatus for replacing a damaged portion of a farrowing crate floor grate.

It is another object of the present invention to provide a method for replacing only that portion of a farrowing crate which is subject to damage.

It is another object of the present invention to provide a method for replacing the damaged portion of a farrowing crate more quickly and economically than was heretofore possible.

### RELATED ART

Applicant is aware of the following U.S. Patents concerning farrowing crates:

U.S. Pat. No. 5,596,951 relates to an animal box floor comprising facilities for the evacuation of excrement formed on the surface of the floor which is mounted above the facilities, such as a ditch for the gathering of the excrement. According to the invention, the arrangement is characterized by the fact that the facilities are comprised of at least a section of the floor which is inclined in relation to the surface of the floor towards an evacuation orifice for the excrement, located in an approximately vertical plan and emptying onto the facilities for gathering the excrement.

U.S. Pat. No. 5,937,793 teaches flooring for a farrowing crate, particularly for pigs, which is formed of beams and support flanges manufactured of glass fiber reinforced resin so as to be electrically insulating. The beams span a pit for receiving manure. On top of the supporting structure is provided a flooring formed of a plurality of rectangular panels or tiles arranged side to side and edge to edge to form an array of the panels. An area under the sow is defined of pressure molded aluminum bars and an area fully surrounding an island of aluminum panels is defined by panels of injection molded plastics which are again non-conductive. The steel structure of the farrowing crate is bolted to the plastic panels at positions forwardly and rearwardly of the island of aluminum panels. Thus the aluminum panels and the non-conductive support beams from any electrically conductive element within the farrowing crate to prevent galvanic corrosion of the aluminum panels. Where the aluminum beams are extruded they can be hollow to allow the passage of a cooling fluid to cool the sow. A heat pump is used to transfer the heat from the sow to the piglets on the plastic panels.

### SUMMARY OF THE INVENTION

The present invention is an improved method and apparatus for repairing a farrowing crate, particularly a portion of the grating floor of the crate which is frequently damaged and in need of replacement. The method provides for cutting and removing a rectangular portion of the grate including the damaged portion, then replacing it with a removable and replaceable section, and fastening the removable section into place. The apparatus includes a receiving and positioning bar for connecting one transverse end of the replacement section to the basic grate, a longitudinal seal-plate member attached to each longitudinal side of the replacement section, and an attachment device for fixing and holding the replacement section firmly in the operating position. Longitudinal grate support members may be provided which are affixed to the underside of the longitudinal edges of the basic grate.

### BRIEF DESCRIPTION OF THE DRAWINGS

The foregoing and other objects will become more readily apparent by referring to the following detailed description and the appended drawings in which:

FIG. 1 is a top view of a farrowing crate showing rails for confining the sow centrally and having a damaged section.

FIG. 2 is a top view of a farrowing crate with a damaged portion of the grate removed.

FIG. 3 is a generally top view of a farrowing crate with utilizing the present invention.

FIG. 4 is an isometric view of a replacement grate section according to the invention.

FIG. 5 is a cross sectional view of a header for locating and retaining the replacement section.

FIG. 6 is a cross sectional view of an alternative header for locating and retaining the replacement section.

FIG. 7 is a cross sectional view of a side bar for positioning and retaining the replacement section.

FIG. 8 is a cross sectional view of an alternative side bar for positioning and retaining the replacement section.

FIG. 9 is a cross sectional view of another alternative side bar for positioning and retaining the replacement section.

FIG. 10 is a top view of a farrowing crate arrangement for an alternative replacement section, showing a damaged portion of the grate removed.

FIG. 11 is a generally top view of the farrowing crate of FIG. 10 with an alternative replacement section in place according to the present invention.

FIG. 12 is an isometric view of a replacement grate section according to the invention embodied in FIGS. 10 and 11.

FIG. 13 is a partial cross section of the alternative replacement grate section according to FIGS. 10 through 12, and showing the side support.

### DETAILED DESCRIPTION

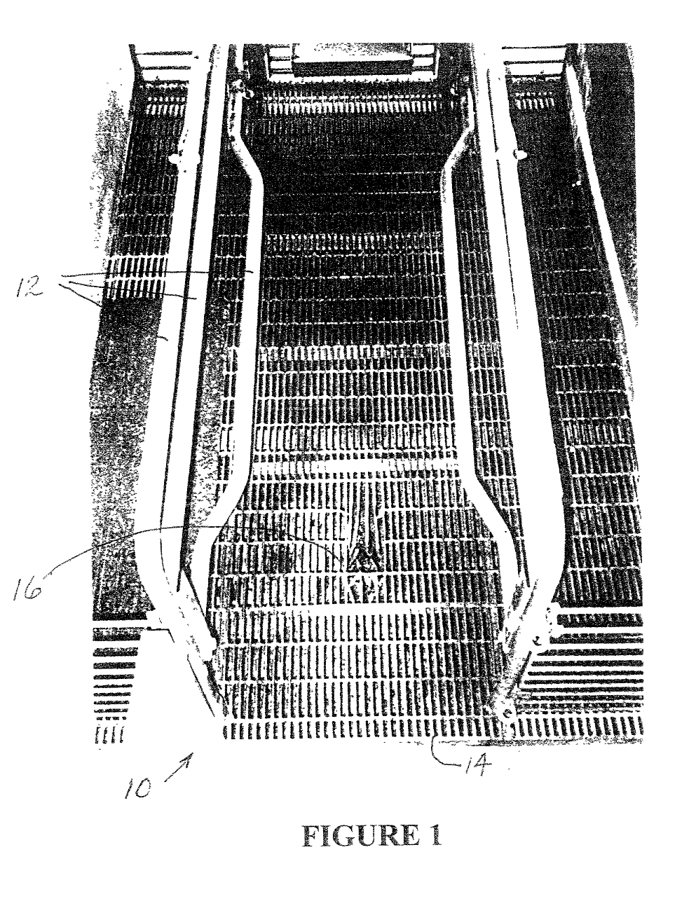

Referring now to the drawings, and particularly to FIG. 1, a farrowing crate 10 includes side bars 12 for preventing the sow from laying on the piglets. The flooring section of the farrowing crate is a floor grate 14, which can have any desired grating form, through which wastes may pass for removal.

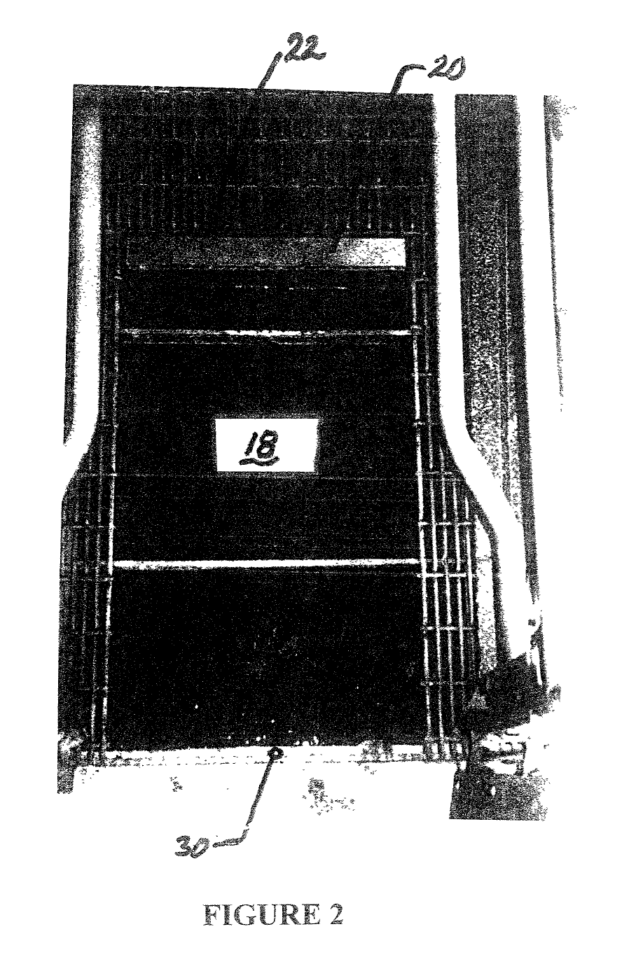

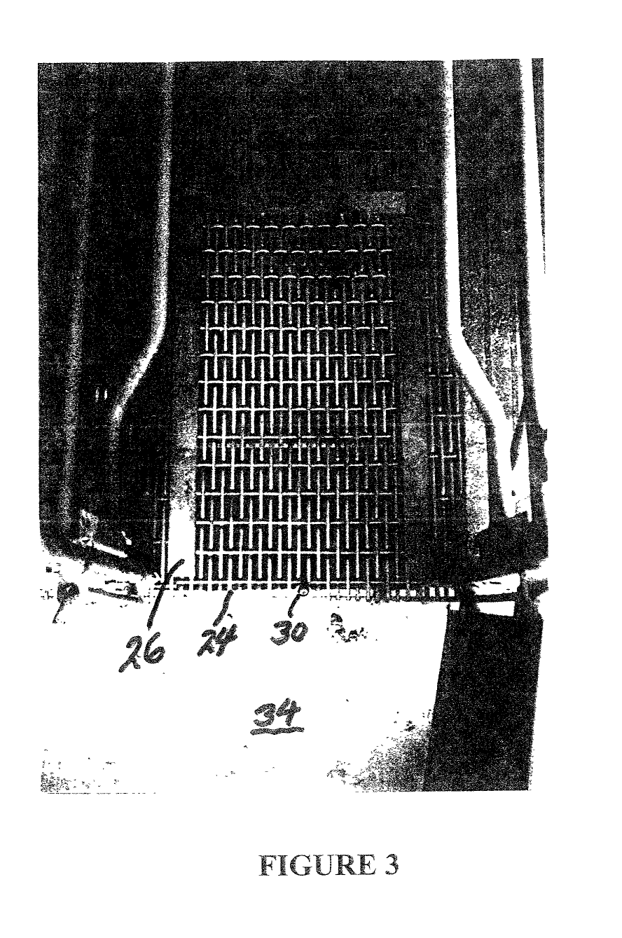

In accordance with the present invention, when it has been determined that the grate 14 should be replaced, the area subject to damage indicated as area 16 in FIG. 1, is cut out. A burning torch, a metal saw, a laser cutter, or any other desired cutting apparatus can be used. The grate from area 16 is then removed, leaving a rectangular opening 18 (see FIG. 2) in the end of floor grate 14. An H-beam header 20 is positioned on the end 22 of the existing grate forming opening 18. A replacement grate 24 is provided with sidebars or rails 26 which are fixed to the top of the replacement grate, preferably by welding. The replacement grate 24 is dimensioned to fit within opening 18 with one end in slot 28 of the H-beam header and the sidebars 26 on top of the edges of grate 14 forming the opening 18.

An anchor device is fixed to the grate support 34, which is normally the adjacent floor. The anchor is preferably a threaded stud 30 and retaining nut 32 which are provided to fix the replacement grate 24 in the operating position.

Once the initial installation of a replacement grate has been completed, it is readily apparent that the further replacement of grate 24 requires only the steps of removal of the nut 32, lifting and removal of the grate 24, then insertion an undamaged grate 24.

### ALTERNATIVE EMBODIMENTS

The cross-section of the top of the H-beam header 20 can be rounded as shown in FIG. 6, rather than flat as in FIG. 5.

The cross-section of the side bar 26 can be rectangular as shown in FIG. 7, or it can be rounded on its upper side as shown in FIG. 8. Alternatively, the side bar can have the lower case letter “h” shape 36 of FIG. 9, whereby the replacement grate 24 fits within the recess 38.

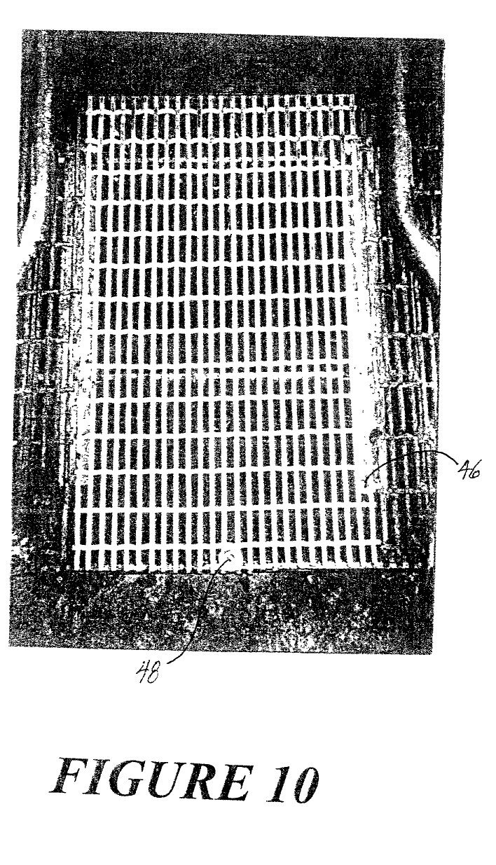

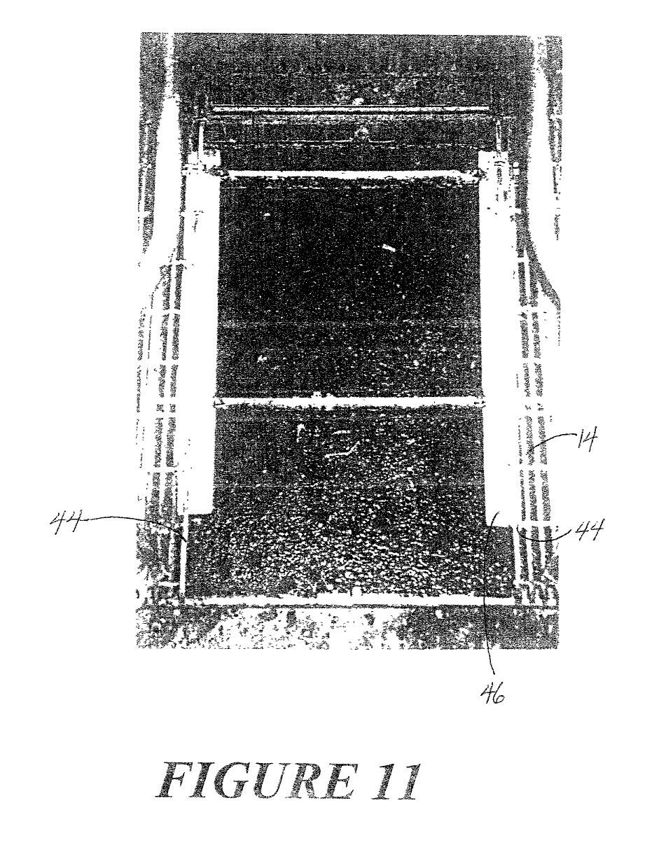

As shown in FIGS. 10 through 13, side support 46 can be fixed to the free edges 44 of the grate 14 which are exposed on removal of the grate from area 16. Side support 46 is welded or otherwise fastened to the underside of the grate edges 44, and extends into the hole formed by the removed grate. In this case, replacement grate 24 is inserted into header 20 and positioned with the sides of the grate 24 resting on side supports 46. The grate is then fixed into position by any convenient means such as by an anchor screw 48 or other anchorage which prevents shifting of the grate 24.

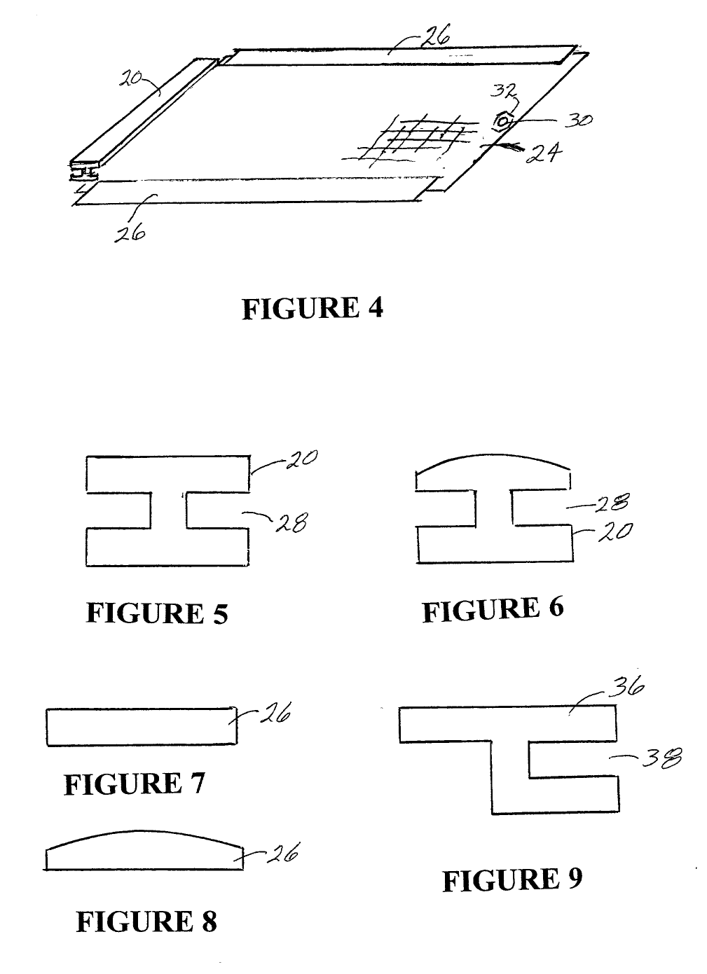

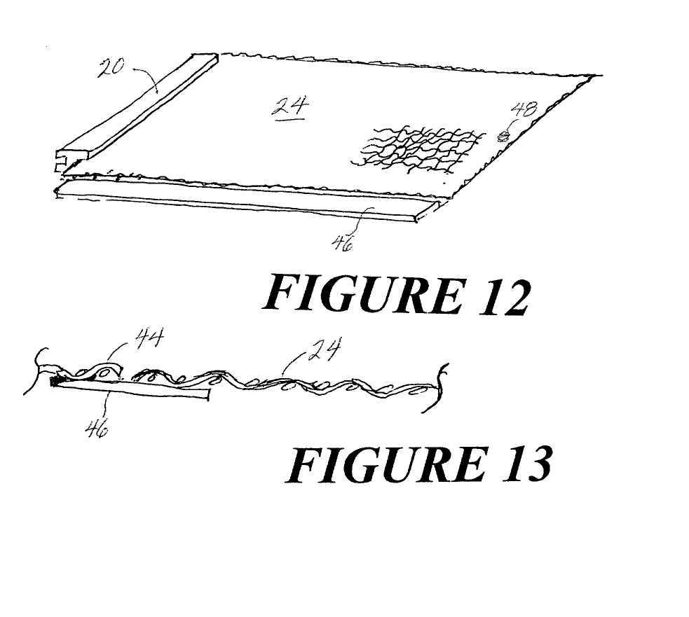

In the embodiment of FIG. 4 it is necessary to weld the wires of insert 24 to the side bar 26. In the embodiment of FIG. 12, the side support 46 is fixed to the existing grate rather than to the insert, thus the side support is not removed with the damaged grate in the event that there was a further replacement of the insert, which is to be expected. The grate of FIG. 12 is easier to clean than the grate of FIG. 4 particularly by use of a power washer.

Although steel grates are preferred, it is possible to utilize other materials including stainless steel, aluminum and certain high-strength plastics. In addition, the header and sidebars can be made from any material having sufficient strength to withstand the weight of a sow.

### SUMMARY OF THE ACHIEVEMENT OF THE OBJECTS OF THE INVENTION

From the foregoing, it is readily apparent that I have invented an improved method and apparatus for repairing a damaged farrowing crate floor grate, which repairs only that portion of a farrowing crate which is subject to damage, and which does so faster and more economically than heretofore has been possible.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A method for repairing damaged grating comprising:
removing a rectangular section from one end of an existing damaged grating, leaving a portion of the existing grating on each side of the removed section, resulting in the existing grating defining an opening having a recessed and exposed end:
supplying a grating insert having sides affixed to opposed edges of the grating insert and opposing free ends;
placing a grate receiving and positioning member on the exposed recessed free end of the existing grating, said grate receiving and positioning member having opposed horizontal slots;
placing the grating insert into the opening left by the removed grating,
engaging the grating insert into a horizontal slot in the grate receiving and positioning member; and
fixing the free end of the grating insert to prevent movement thereof.

2. A method for repairing damaged grating comprising:
removing a rectangular section from one end of an existing damaged grating, leaving a portion of the existing grating on each side of the removed section, resulting in the existing grating defining an opening having opposed side edges, and an exposed end:
establishing a bottom support means to support a replacement grating insert, and fixing said support means to the opposed side edges of the opening;
providing a grating insert having dimensions adapted to fit within the opening in said grate;
placing a grate receiving and positioning engaging member on the exposed recessed free end of the existing grating;
placing the grating insert into the opening left by the removed grating,
engaging the grating insert into a horizontal slot in the engaging member; and
fixing the free end of the grating insert to prevent movement thereof.

3. Apparatus for replacing a damaged portion of a grate, comprising:
a rectangular replacement grate;
a receiving and positioning member for connecting an end of said replacement grate to the basic grate;
a longitudinal seal-plate member attached to each longitudinal side of said replacement grate; and
means for fixing said replacement grate firmly into the operating position.

4. Apparatus according to claim 3, wherein said longitudinal seal plate member is fixed to the top of each side of the grate by welding.

5. Apparatus according to claim 3, wherein each longitudinal member has a generally flat cross-section.

6. Apparatus according to claim 3, wherein each longitudinal seal plate member has a cross-section which is generally the lower case letter “h” for receiving the replacement grate therein and for removably engaging each edge of the original grate.

7. Apparatus, according to claim 3, wherein said grate receiving and positioning member has opposed slots, one for engaging the original grate and the other for engaging the end of the replacement grate.

8. An apparatus, according to claim 3, wherein said fixing means comprises a stud fixed to a grate support, and means for holding said replacement grate on said stud.

9. Apparatus according to claim 8, wherein said stud is threaded, and a nut is attachable to said threaded stud.

10. Apparatus for replacing a portion of a basic grate having a rectangular opening formed by removal of a portion of the grate therefrom, comprising:
a rectangular replacement grate;
a receiving and positioning member for connecting an end of said replacement grate to the basic grate;
a pair of longitudinal support members, one attached to each longitudinal exposed side of said basic grate and extending into said opening; and
means for fixing said replacement grate firmly into the operating position.

11. Apparatus according to claim 10, wherein said longitudinal support member is fixed to the bottom of each side of the edge of said opening of the basic grate by welding.

12. Apparatus according to claim 10, wherein said grate receiving and positioning member has opposed slots, one for engaging the basic grate and the other for engaging the end of the replacement grate.

13. An apparatus, according to claim 12, wherein said fixing means comprises a stud fixed to a grate support, and means for holding said replacement grate on said stud.

14. Apparatus according to claim 13, wherein said stud is threaded, and a nut is attachable to said threaded stud.
